(19) United States
(12) Patent Application Publication
(10) Pub. No.: US 2008/0251451 A1
(43) Pub. Date: Oct. 16, 2008

(54) Method and Apparatus for the Aerobic Treatment of Waste

(76) Inventors: Stuart Christian, West Yorkshire (GB); Nicholas Foster, West Yorkshire (GB)

Correspondence Address: NIXON PEABODY LLP - PATENT GROUP, 1100 CLINTON SQUARE, ROCHESTER, NY, 14604, US

(21) Appl. No.: 12/066,364

(22) PCT Filed: Sep. 8, 2006
(86) PCT No.: PCT/GB06/50282

§ 371 Date: Mar. 10, 2008

(30) Foreign Application Priority Data
Sep. 10, 2005 (GB) 0518508.7

(51) Int. Cl. C02F 3/12; C02F 3/34

(52) U.S. Cl. 210/614; 210/150; 210/138; 210/143; 210/620

(57) ABSTRACT

The invention provides a waste treatment apparatus for the microbial treatment of waste, and comprises at least one reactor vessel (12) for containing waste, waste feed means (7) adapted to feed untreated waste into the vessel, microbial feed means (48) adapted, in use, to feed micro-organisms into the waste, aeration means (28) adapted to aerate the waste in the vessel, and waste outlet means (5) adapted to remove treated waste from the vessel. The invention also provides a method of treating waste, using the apparatus.

The present invention relates to the treatment of waste, and particularly to the treatment of wastewater and the degradation of organic waste. The invention extends to apparatus and methods for degrading organic waste and treating wastewater.

The traditional biological method used for degrading sewage and for treating wastewater streams involves the use of naturally occurring micro-organisms, predominantly bacteria. Sewage to be treated is first allowed to settle in a vessel. The clarified liquor is then decanted off from the solids, and is then aerated continuously for several days. The supply of oxygen causes bacteria within the sewage to grow, which then degrade the sewage. Following aeration, the sewage is allowed to settle, such that a sludge, which consists of partially degraded sewage and flocculations of bacteria, drops to the bottom of the vessel. A supernatant of partially treated sewage water and less dense particles of waste forms above the sludge. The result of the aeration combined with the action of the bacteria is a reduction in the concentration of organic matter, referred to as substrate or food, which is typically measured as Biochemical Oxygen Demand (BOD).

However, if a small quantity of the settled sludge is removed from the vessel, and added to a fresh batch of settled sewage in a second vessel, and the aeration process repeated, a further improvement will be observed, in that the BOD of the new supernatant will decrease even further than in the first vessel. If this cycle of settling and aerating sewage is repeated several times, a substantial culture of biologically active flocculating micro-organisms will be developed in the sludge. These micro-organisms are added to primary settled sewage and aerated for a few hours, followed by a settlement step. The result is about a 95% reduction in the BOD in the sewage. The volume of sludge is then maintained such that a substantial concentration of bacteria is retained for the degradation of further sewage.

Ardern and Lockett (Experiments on the Oxidation of Sewage Without the Aid of Filters, J. Soc. Chem. Ind. 1914, 33 (10)) discovered this so-called ‘activated’ sludge treatment process in 1913, which led to the development of the first fully operational activated sludge plant for sewage treatment to be built in 1917. Since then, the process of activated sludge treatment has become the favoured treatment method for urban wastewater treatment, and is also used widely in industrial organic wastewater applications.

Research is continually being carried out within the water treatment industry to identify new and more environmentally friendly methods for dealing with ever more complex waste streams emanating from more complex manufacturing processes. Although global waste minimisation is an essential issue to encourage efficiency in manufacturing processes, there will always be those processes that produce contaminated wastewater streams, which in turn require cleaning.

Since the late 1970s, developments and advances have taken place in the production and use of enzymes and freeze dried bacteria in sewage and wastewater treatment. These products are frequently used in industrial processes including the pharmaceutical industry, the food processing industry and the textile industry. For example, towards the end of 1979, freeze dried bacteria products became available for the wastewater treatment industry with the early products being used for grease and fat removal in kitchen fat traps and ‘u’ bends. Later developments included biological floor cleaners and freeze-dried cultures for improving cesspit and septic tank performances. Many companies have started to recommend the addition of freeze dried bacteria to existing sewage and effluent treatment systems, although research on the actual effect and improvement in operating efficiency is extremely limited.

Although activated sludge technology has become the favoured method for the biological treatment of organic wastewater streams, it suffers from a large number of inherent problems. For example, the treatment process relies on the natural growth of bacteria within the sewage and hence, sludge, and requires the ‘correct’ bacteria to be cultivated, which are capable of effectively digesting the waste. However, the wrong species of bacteria can easily reproduce in the digestion vessel, and these ‘incorrect’ bacteria can out-compete the correct bacteria, and consequently inhibit the efficiency of the system, or even prevent it from working at all. Hence, the process is incapable of tolerating large swings in strength or type of microbial contamination. In addition, the process is highly susceptible to toxic shocks and has a very slow recovery rate if a micro-organism culture wipe out occurs A further problem with the existing activated sludge protocols is that a high volume of surplus sludge is produced. This sludge is bulky and requires disposal, which is expensive. The routes available for the disposal of sludges derived from wastewater treatment are becoming more tightly controlled due to environmental pressures and costs of land-fill and incineration are rising due to shortage of facilities and more complex policing.

Another problem with existing methods is that a high level of operational expertise is required to operate waste water/sewage treatment plants efficiently, and the operatives need a good grounding in biological techniques of wastewater treatment. Hence, there is a requirement for constant staff attention to ensure that the system operates efficiently. Furthermore, a high level of control is required over the levels of solids retained and returned within the process, as is a full understanding of the effect of varying the levels of these solids on the overall performance of the system. In addition, due to the large number of vessels required, the systems tend to occupy a large footprint (surface area) and increasing a systems capacity is often time-consuming and expensive. Because of its large footprint requirement, activated sludge treatment often proves impractical for industrial purposes where companies are short of space, even though the process would be the most environmentally suitable for the purpose.

It is therefore an aim of embodiments of the present invention, to address the problems with the prior art and to provide an improved method and apparatus for treating wastewater, and for digesting waste.

Many researchers involved with activated sludge treatments assume that simply adding additional bacteria to the sludge in a digestion vessel would improve the performance of the system without understanding the ‘effect’ of the process conditions in which the bacteria are expected to live and breed. Although industry has started to provide pre-cultured, specific strain ‘packages’, the knowledge of how to use them is still very limited and is restricted to existing systems, primarily the activated sludge process. Hence, the ability to use specific strain cultivation is limited.

Hence, the inventors of the present invention decided to investigate the biological mechanisms involved in activated sludge treatment regimes for wastewater and other waste.

According to a first aspect of the present invention, there is provided waste treatment apparatus for the microbial treatment of waste, the apparatus comprising at least one reactor vessel for containing waste, waste feed means adapted to feed untreated waste into the vessel, microbial feed means adapted, in use, to feed micro-organisms into the waste, aeration means adapted to aerate the waste in the vessel, and waste outlet means adapted to remove treated waste from the vessel.

It will be appreciated that the provision of the microbial feed means advantageously allows total and effective control over the specific micro-organism strain or strains used in the apparatus during the treatment of the waste therein. This is a significant advantage over existing technology, which relies on naturally occurring micro-organisms within the waste to populate the vessel and digest the waste. Hence, the microbial feed means of the apparatus according to the invention obviates the serious drawback inherent with the prior art, and does not rely on the ‘correct’ micro-organisms to be cultivated in the vessel, which can not be guaranteed. The microbial feed means ensures that the ‘correct’ species of micro-organisms is always maintained in the vessel, and hence, does not suffer from another problem with the prior art that the micro-organisms can mutate into ‘incorrect’ species, which can easily reproduce in the treatment vessel. Hence, the correct species are never out-competed by any mutant species. Hence, the apparatus according to the invention is capable of tolerating large swings in strength or type of microbial contamination. In addition, the process is highly resistant to toxic shocks and has a very fast recovery rate should the correct micro-organism culture ever be wiped out.

Furthermore, the inventors believe that, to date, it has not been realised that it would be possible to efficiently control the species of micro-organisms that could be used to treat the waste. It was not appreciated that it would be possible to cultivate the required micro-organisms separately from the process without having to carry out major re-designing of the traditional handling process for the microbial culture to operate in. Existing biological treatment processes are designed to provide a fixed system for micro-organisms to grow in and the limiting factor placed on the ability of micro-organisms to grow or perform is due to pre-determined retention times, inefficient oxygen delivery, sludge return and mixing systems. Such problems are solved by the apparatus in accordance with the first aspect of the invention due to the provision of the microbial feed means.

The microbial feed means may comprise a culture vessel in which micro-organisms may be cultured prior to feeding into the waste. It will be appreciated that it is preferred that the micro-organisms are activated or ‘woken up’ prior to mixing them with the untreated waste. This is required so that the micro-organisms are metabolically primed to digest and thereby treat the waste. Hence, preferably, the culture vessel may comprise an activation chamber in which the micro-organisms are fed nutrients and maintained at the correct temperature in order to accelerate the microbial activation process.

The microbial feed means may comprise dosing means, which may be adapted to automatically dose or feed a pre-determined quantity of micro-organisms from the culture vessel into the waste. The dosing means may be adapted to feed the micro-organisms either directly into the vessel itself and/or into the waste feed means. The dosing means may comprise an auger doser. The microbial feed means may comprise a timer adapted to control when the dosing means feeds the micro-organisms into the waste. Advantageously, the microbial feed means including the timer and the dosing means provides tight control of the amount and timing of feeding the micro-organisms into the waste to be treated.

It will be appreciated that the source of the waste to be treated using the apparatus according to the invention, is not limited to any particular industry. However, it will be appreciated that the waste will be generally toxic or contain toxins. Examples of waste, which may be treated with the apparatus may be commercial or industrial waste streams, for example, those from the food processing industry; abattoirs; the oil industry; landfill leachate; agricultural residues; and the chemical industry. Hence, the waste may comprise wastewater, effluent and/or waste sewage etc. Preferably, the waste comprises organic matter. Preferably, the apparatus is used for the treatment of Urban Sewage.

The waste may be substantially fluid. However, the waste may comprise a liquid/solid mix. The solids may be particulate, which may be suspended in the liquid. Hence, when in use, the reactor vessel is substantially filled with a waste fluid substance. Hence, it is preferred that the reactor vessel is not a packed bed reactor.

The micro-organisms are preferably adapted to treat or digest the waste in the vessel. The terms “treat the waste” or “digest the waste” are used interchangeably herein, and refer to converting the waste into a degraded and less toxic form.

Preferably, the apparatus is adapted in use to reduce the chemical oxygen demand (COD) and the biological oxygen demand (BOD). Suitably, the apparatus is adapted in use to reduce the chemical oxygen demand (COD) of the waste by at least 30%, more suitably by at least 40% and even more suitably by at least 50%. It is preferred that the apparatus is adapted in use to reduce COD of the waste by at least 60%, more preferably, by at least 70% and even more preferably, by at least 80%. Surprisingly, as described in the Examples, the apparatus can reduce the COD by at least 90%, and in some embodiments, by at least 95%. It will be appreciated that this is a major improvement over current technology.

Suitably, the apparatus is adapted in use to reduce the biological oxygen demand (BOD) of the waste by at least 30%, more suitably by at least 40% and even more suitably by at least 50%. It is preferred that the apparatus is adapted in use to reduce BOD of the waste by at least 60%, more preferably, by at least 70% and even more preferably, by at least 80%. Surprisingly, as described in the Examples, the apparatus can reduce the BOD by at least 90%, and in some embodiments, by at least 95%. It will be appreciated that this is a major improvement over current technology.

Such conversion will be carried out biochemically by the micro-organisms themselves. The skilled technician will appreciate the various species of micro-organisms, which may be used to treat waste in the apparatus according to the invention. It is preferred that the micro-organisms used for treating the waste are bacteria, and it will be appreciated that the species of bacteria used in the apparatus will be determined by the type and quantity of waste to be treated.

By way of example only, suitable bacteria include Bacillus spp. Bacillus spp. may be used to treat waste derived from food waste, and household sewage. Preferred strains include Bacillus subtilis, Bacillus megaterium, Bacillus thurengesis, Bacillus stearothermophilus, Bacillus lichenformis, Bacillus polymyxa, and Bacillus pumulis. Another suitable micro-organism includes Lactobacillus spp, and preferably, Lactobacillus sporogenes or Lactobacillus aeruginosa (non pathogenic). Lactobacillus spp may be used to treat waste derived from dairy products.

Another suitable micro-organism includes Pseudomonas spp. and preferably, Pseudomonas flourescens or Pseudomonas stutzeri. Pseudomonas spp may be used to treat waste derived from pharmaceutical industry. Another suitable micro-organism includes Cellulomonas spp., and preferably, Cellulomonas uda. Cellulomonas spp. may be used to treat waste derived from plant products.

Another suitable micro-organism includes Micrococcus spp. Micrococcus spp may be used to waste derived from petrochemical industry. Another suitable micro-organism includes Thiobacillus spp., and preferably, Thiobacillus novellas. Thiobacillus spp may be used to waste derived from sulphide producing processes with strong odours. Another suitable micro-organism includes yeast, such as Sacchormyces spp, and preferably, S. cerevsiae. Yeast may be used to treat waste derived from the brewing industry.

Preferably, the waste feed means is adapted in use to feed untreated waste towards or into an upper region of the reactor vessel. Preferably, the waste feed means feeds untreated waste in to the top of the reactor vessel. Preferably, the waste outlet means is adapted to remove treated waste from a lower region of the reactor vessel. Preferably, the waste outlet means removes treated waste from the bottom of the reactor vessel.

Advantageously, feeding the untreated waste in to the upper region of the reactor vessel and removing the treated waste from the lower region of the vessel causes the waste to drop or sink downwardly through the reactor vessel. This generally downwards movement is provided by gravity and also due to a generally downwardly flow. The time the waste spends in the reactor vessel is referred to as the retention time of the waste in the reactor vessel. It is preferred that by feeding the waste in from the top and removing it from the bottom it provides a sufficient retention time for the micro-organisms to come into contact with, and bind to, the waste, thereby forming flocculations. By the term “flocculation”, we mean the combination, agglomeration, aggregation or coagulation of suspended particles in such a way that they form small clumps or tufts (called flocs).

Preferably, the aeration means is adapted in use to increase the retention time of the waste in the vessel. This is made possible because the aeration means is operable to generate a current within the waste in the vessel, which current provides lift to the waste. Preferably, the current flows generally in an upwardly direction, i.e. in an opposite direction to the generally downwardly flow caused by feeding the untreated waste into the top of the reactor vessel and removing treated waste from the bottom of the reactor vessel. Hence, the provision of the aeration means is advantageous because it increases the retention time for the waste in the vessel and also provided the lift, which increases the time for flocculations to form between the waste and the micro-organisms in the vessel. It will be appreciated that the flocculations of waste and micro-organisms results in the digestion of the waste, and so by increasing the number of flocs improves the efficiency of the apparatus.

Preferably, the aeration means is adapted to produce a plurality of gas bubbles, which rise up from the lower region of the vessel, and which bubbles provides the lift to particles of waste, micro-organisms, and flocculations thereof inside the vessel. Preferably, the bubbles form an aeration matrix within the vessel.

Preferably, the aeration means comprises at least one gas diffusion means disposed substantially at or towards a lower region of the inside of the vessel. Preferably, the gas diffusion means points in a direction, which is substantially parallel with a longitudinal axis of the vessel. Hence, when the vessel is in use, the gas diffusion means points upwardly. Preferably, the aeration means comprises a plurality of gas diffusion means, disposed at or towards the base of the vessel, each of which points along the longitudinal axis of the vessel, and therefore upwardly when the vessel is in use. Preferably, the plurality of gas diffusion means forms an array arranged along the base of the vessel. Preferably, the array is disposed substantially horizontally when the vessel is in use.

Preferably, the aeration means comprises a gas supply in communication with the or each gas diffusion means, preferably via a gas conduit. Preferably, the gas comprises oxygen, which is provided to enable the micro-organisms to grow and digest the waste inside the vessel. Hence, preferably, the waste treatment reaction is substantially aerobic. For example, the gas may comprise air. The aeration means may comprise means to urge gas along the gas conduit from the gas supply to the or gas diffusion means. Preferably, the said means comprises a blower, which may be a positive displacement blower.

The or each gas diffusion means may comprise support means and at least one aperture extending therethrough, which aperture is in communication with the gas conduit. The support means may comprise a substantially circular disc. Preferably, the or each gas diffusion means comprises a plurality of apertures, each of which is connected to the gas conduit. The plurality of apertures may be arranged around the circumference of the support means. Preferably, the support means comprises at least two sets of apertures arranged around its circumference, which apertures are radially spaced apart.

Preferably, each aperture comprises a gas diffuser, arranged in use to produce bubbles of gas. Preferably, the gas diffuser in use points in a direction, which is substantially parallel with a longitudinal axis of the vessel. The gas diffuser may be dome shaped. The gas diffuser preferably comprises a membrane disposed over the aperture, which membrane is preferably perforated. The perforations in the membrane may be formed as apertures or narrow slits in the membrane, which preferably are adapted to open up as gas is pumped therethrough. Preferably, the apertures or slits are adapted to close when the gas supply is turned off thereby preventing back flow of liquor into the aeration means. The slit size varies with the pressure of air, but the nature of the dome preferably ensures that the apertures do not exceed about 0.25 mm in diameter.

Preferably, the membrane is substantially flexible, and is preferably adapted to expand outwards (upwardly) when gas feeding from the gas supply is passed therethrough. For example, the membrane may be made of a resilient material, such as rubber. Advantageously, the perforations in the membrane emit a very fine bubble matrix at a controlled rate throughout the vessel. Hence, it will be appreciated that the configuration of the aeration means as a whole ensures an equal distribution of gas across the diameter of the reactor vessel. It will be appreciated that the number of individual air diffusers mounted in the vessel will depend on the diameter of the vessel and the calculated oxygen requirements of the waste to be degraded.

Advantageously, the aeration means delivers large volumes of oxygen to support the growth requirements of the micro-organisms in the culture growing within the reactor vessel. In addition, sufficient air bubbles are produced by the aeration means in order to provide sufficient lift to the bacteria and waste particles, but without producing excessive turbulence. Turbulence would disturb the optimum flow pattern within the vessel and affect the digestion of the waste, and so has to be avoided as much as possible.

Preferably, the vessel comprises means to determine dissolved oxygen concentration in the waste, which means may comprise a dissolved oxygen probe. Preferably, the vessel comprises an oxygen probe at the top and at the bottom of the vessel, and preferably, approximately, in the middle of the vessel such placement of probes enables optimum monitoring throughout the vessel. Aeration adjustments may be made by altering the pressure of the gas entering the vessel, for example, by varying the speed of the positive displacement blower(s) in the gas supply.

It will be appreciated that the dimensions of the reactor vessel are an important feature of the invention. The precise dimensions of the vessel will be determined by the volume of waste, which requires treatment in the apparatus according to the invention, and also how many reactor vessels there are. However, it is preferred that the height of the reactor vessel is at least twice that of its width, and this is required for the efficient running of the reactor vessel, and hence, degradation of the waste.

Prior art apparatus require the use of a pre-treatment step, for example, using DAFF unit and/or a settlement tanks to pre-treat the waste before full treatment. Such pre-treatment units involve the use of dangerous chemicals, and requires leaving the waste to be pre-treated for a period of time before full treatment, which wastes time. Furthermore, pre-treatment makes the waste sludge heavy which hinders later full treatment. Unlike currently available waste treatment apparatus used to treat waste having high BOD and COD counts, there is no need to do any so-called “pre-treatment steps” prior to feeding the waste into the vessel of the apparatus according to the invention.

However, the apparatus may comprise means for removing undigestible particles from the waste prior to feeding into the vessel, which means may comprise a screen. Basic screening or filtering does not constitute a pre-treatment step. The apparatus may comprise a receiving sump adapted to store the waste flowing from the screen. The apparatus may comprise pumping means adapted to pump waste via the waste feed means to the vessel. The pumping means may comprise a grinder pump. The apparatus may comprise a balance tank adapted to store the waste prior to feeding into the reactor vessel. The apparatus may comprise pumping means adapted to pump treated waste out of the vessel through the waste outlet means.

The apparatus may comprise a plurality of reactor vessels, which may be adapted to run either independently or simultaneously from each other. The apparatus may comprise means for further treating the treated waste exiting the or each reactor vessel. Suitable means may comprise further screening means, which may be independently selected from a group consisting of: a screening stage; a settlement stage; a dissolved air flotation stage; or a combination of each. Depending on the final disposal route of the treated waste, it may pass either directly to a sewer where it may circulate with other wastewater streams, or to a further treatment unit for final ‘polishing’, and re-use. For example, the treatment unit may comprise either (a) an NSAFF (or Nitrifying Submerged Aerated Fixed Film Filter); and/or (b) a reed bed used for polishing relatively clean wastewater to river water quality; and/or a DAFF unit. Chemicals may be used in these polishing steps. However, much lower concentrations and amounts are required than existing apparatuses as the BOD and COD levels are reduced much more using the apparatus according to the invention. Chemicals may not even be required at all in these polishing steps.

The apparatus preferably comprises a controller linked to processing means. For example, the controller and processing means may comprise a control-panel mounted plc (programmable logic controller), or a small computer. Preferably, the oxygen probes are in operable communication with the controller, and hence, processing means. There may be a number of dissolved oxygen probes within the vessel depending on the size of the vessel, but preferably, a minimum of two probes per vessel.

The apparatus may comprise a modem or other form of remote linkage, so that information from the vessel may be fed from the controller and processing means through the modem to a remote terminal, which may be situated in another town, or country from which a central control unit may manage the entire process.

According to a second aspect of the present invention, there is provided a method of microbially treating waste, the method comprising the steps of:—
(i) feeding untreated waste into at least one reactor vessel via waste feed means;
(ii) feeding micro-organisms into the waste via microbial feed means;
(iii) aerating waste in the vessel via aeration means; and
(iv) removing treated waste from the vessel via waste outlet means.

Preferably, the method of the second method comprises use of the apparatus according to the first aspect. The method may be run continuously, and may therefore be referred to as a continuous reaction, preferably under state-state conditions. Hence, preferably, steps (i), (iii) and (iv) are continuous. It is preferred that untreated waste is continuously fed into the vessel (step (i)) and treated waste is continuously removed from the vessel (step (iv)), preferably, at substantially the same flow rates. It is preferred that that the waste is continuously aerated in the vessel (step (iii)). Step (ii) may be batch or fed-batch, wherein micro-organisms may be fed intermittently into the waste via the microbial feed means as and when required.

Maintenance energy is that part of the energy requirements of the micro-organism that is used to maintain the cell in a viable state, for example, for re-synthesis of cell constituents which are continuously being degraded, growth, and for maintaining concentration gradients between the interior and exterior of the cell. Maintenance respiration is carried out by the micro-organisms in the reactor vessel when the concentration of substrate provided by the organic content in the waste is sufficiently high.

However, as the micro-organisms treat or digest the waste, the substrate concentration in the waste reduces to levels such that maintenance digestion is unable to be carried out. Endogenous respiration is an alternative metabolic process to maintenance respiration, and occurs in the micro-organisms when the substrate concentration (nutrients in the waste) is substantially reduced from the reactor vessel. It is an alternative mechanism by which the micro-organisms can produce their energy requirements, by using some of their own cellular mass as energy substrate.

Hence, it is preferred that the method comprises causing the micro-organisms to enter an endogenous respiration phase. Preferably, the method comprises temporarily stopping untreated waste from being fed into the reactor vessel (i.e. step (i) is prevented). Preferably, the method comprises stopping treated waste from being removed out of the vessel (i.e. step (iv) is prevented). Hence, the volume of waste in the reactor vessel is kept constant to allow endogenous respiration to take place. It is preferred that the method comprises continuing to aerate the waste present in the reactor vessel (i.e. step (ii) is continued), to thereby provide further oxygen to the micro-organisms therein so that they use endogenous respiration. Hence, under these conditions, the micro-organisms enter a ‘cannibalistic’ form in which they begin to feed off, and consume their own dead biomass. Accordingly, the endogenous metabolism phase refers to reactions that occur within the micro-organisms in the absence of externally supplied substrate from the waste.

The inventors of the present invention have surprisingly found that by controlling the extent to which endogenous respiration occurs within the reactor vessel by stopping further feeding of untreated waste and removal of treated waste, it is possible to control the concentration of biomass in the vessel, which is then produced as sludge. Accordingly, by controlling the endogenous respiration phase in the reactor vessel, using the method of the second aspect it is possible to cause a substantial reduction in the concentration of solid particles discharged from the reactor vessel as sludge, and hence, the apparatus according to the first aspect. This is a major advantage over existing activated sludge processes in which large volumes of sludge are produced, and which require disposal.

Following the endogenous respiration phase, the method preferably comprises feeding further untreated waste into the reactor vessel (i.e. step (i) is re-initiated). Preferably, the method comprises removing further treated waste from the vessel (i.e. step (iv) is re-initiated). Hence, preferably, the method comprises a series of steps comprising (a) continuously feeding and removing waste from the reactor; (b) maintaining a volume of waste in the reactor vessel for a defined period to allow endogenous respiration to occur; and (c) then re-feeding further waste and removing said waste from the reactor. It will be appreciated that the waste is continuously aerated by the aeration means.

The method may comprise using a plurality of reactor vessels, which are preferably operably connected in series with each other. It will be appreciated that in use, it may be preferable to feed untreated waste by the waste feed means to a first vessel for a defined period of time, and then depending on the stage of the waste treatment, feed waste from the waste outlet means of the first vessel to the waste feed means of a second vessel, and so on.

In order to maximise the ‘endogenous respiration’ phase, the reactor vessels used in the method are connected so that they can be run independently of one another. Hence, when a first reactor vessel is arranged to enter into the endogenous respiration mode, further waste may be fed into a second (and other) reactor vessel so that the apparatus is not out of action for any prolonged periods. In this way, the first reactor vessel is set up to digest the majority of the microbial biomass grown up in the reactor vessel, while a second vessel is arranged to digest ‘fresh’ waste from the waste feed means.

Once the endogenous respiration phase has been completed, the first reactor vessel is then preferably fed with fresh untreated water, and the inflow and outflows re-initiated as previously. This allows the first reactor vessel to return to the situation where waste is being degraded within the vessel and the micro-organisms can rely on the fresh waste substrate to provide their maintenance energy. The second reactor vessel may then be induced to enter the endogenous respiration phase by stopping inflow and outflow of waste, but continuing aeration such that the amount of sludge is reduced.

The biological activity in the reactor is preferably monitored by dissolved oxygen probes, which are linked to a controller and processing means. For example, the controller and processing means may comprise a control-panel mounted plc (programmable logic controller), or small computer. There may be a number of dissolved oxygen probes within the reactor depending on the size of the vessel, but preferably, a minimum of two probes per vessel.

An increase in the level of oxygen will indicate that bacterial activity is reducing and more load can be added. A reduction in the level of oxygen will indicate a high level of bacterial activity and load will be reduced. Long periods of low oxygen levels will take the system to the point where all further load is stopped to the vessel for a period of time to allow Endogenous Respiration to take place. The controller will monitor the oxygen levels and automatically adjust the flow of effluent through the system by stopping and starting the feed pumps, or opening and closing automatic valves, depending on the configuration of the process. The controller will also use the information relayed from the probes to adjust the speed of the aerators which will alter the volume of air entering the system and therefore the volume of oxygen available.

Information may also be fed from the controller and processing means (i.e. the plc) through a modem to a remote terminal, which may be situated in another town, or country from which a central control unit may manage the entire process.

Preferably, and advantageously, the controller (ie. plc) allows a number of operating processes to be carried out automatically. Content levels within the reactors may be regulated by the plc via ultrasonic level probes placed in the vessels. The reactors are always kept full, but contents levels may be allowed to vary depending on whether the process is in endogenous respiration mode, normal operational mode or service mode. The levels within the reactors are altered using electric pumps placed after each reactor and which are connected to the controller/processing means. The operating status of the pumps is monitored by the controller and information can be monitored on the remote control terminal where operational decisions can be made.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying diagrammatic drawings, in which:—

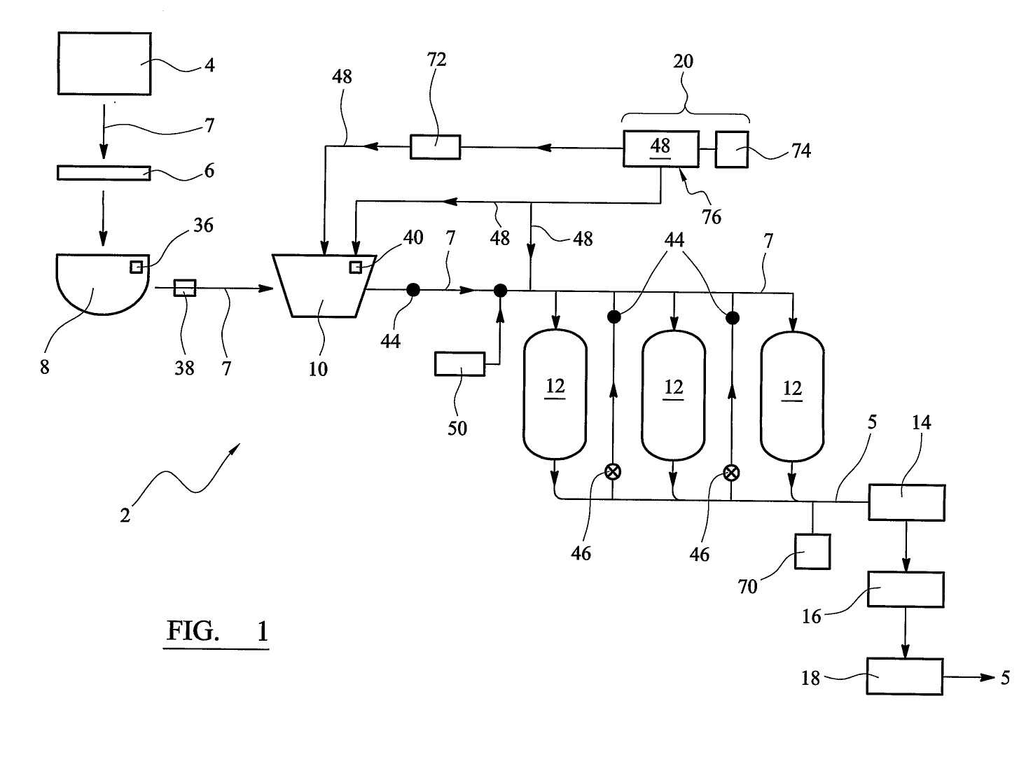

FIG. 1 shows a schematic layout of an apparatus and system for treating organic waste and wastewater;

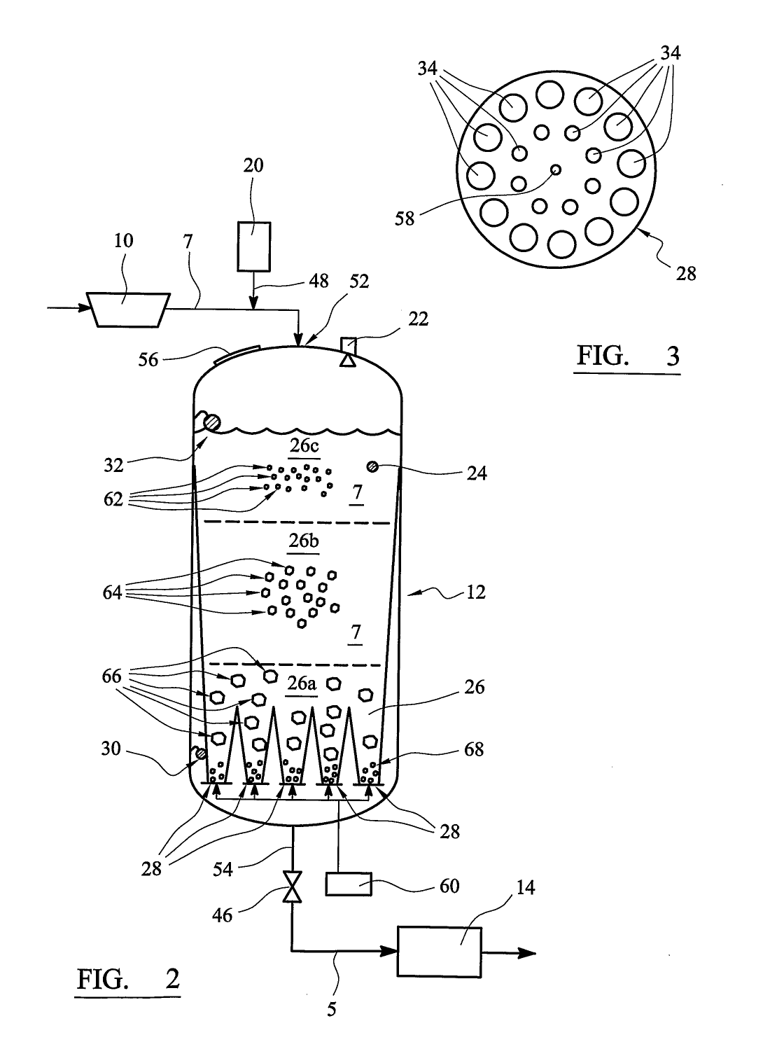

FIG. 2 shows a schematic side view of a reactor in accordance with the invention; and

FIG. 3 shows an enlarged plan view of an air diffuser used in the reactor shown in FIG. 2.

### EXAMPLES

The key disadvantages using traditional waste water treatment processes using activated sludge are (i) it is not possible to allow the bacteria to adequately metabolise the organic waste matter, and (ii) excessive amounts of waste sludge are produced. These disadvantages of existing activated sludge processes have caused the inventors of the present invention to produce an apparatus and a method, which will enable wastewater and/or organic waste (sewage) to be treated significantly more efficiently than has bee possible to date.

### Example 1

Referring to FIG. 1, there is shown a schematic layout of an apparatus 2 devised by the inventors for the treatment of the organic waste and wastewater. The apparatus 2 has been given the acronym NERV (Natural Endogenous Respiration Vessel) system, because the key component of the apparatus 2 is a series of reactors 12 (referred to herein as NERV reactors) 12, in which Endogenous Respiration is controlled. This is described in further detail below. The NERV reactor 12 is shown in detail in FIGS. 2 and 3, and will be described hereinafter.

### (1) The NERV System

The NERV system consists of an apparatus 2 for the complete treatment and degradation of wastewater or waste 7 from a waste source 4. The apparatus 2 consists of an initial screen 6, a flow balance 10, and a series of NERV reactors 12 in which the biological degradation of the waste 7 is carried out. Waste particles or sludge, which is produced as by-products of the treatment process, is removed and stored in a sludge removal device 70, and cleared liquor 5 may then be further treated. The apparatus 2 consists of a final clarification device 14, and a residual conditioning device 16. When all of these devices are linked together, the apparatus 2 may be used to perform a complete wastewater cleaning or treatment process. The resultant, treated liquor stream 5, which is produced can then be safely disposed of, for example, down a sewer 18.

Referring to FIG. 1 in more detail, the apparatus 2 consists of a source 4 of waste 7. The waste can be wastewater, effluent or waste sewage 4. It will be appreciated that the source of the waste 7 to be treated using the apparatus 2, is not limited to any particular industry, and examples of industrial waste streams 4, which can be treated include those from: Food processing; Abattoirs; the Oil industry; Landfill leachate; Agricultural residues; and the Chemical industry. In addition, the process can also be of particular importance in the treatment of Urban Sewage 4. For the purposes of the following description, the term “waste” 7 is used to define the source of wastewater/sewage 7 to be treated by the NERV apparatus 2.

Waste 7 to be treated is first passed from the source 4 through a primary screen 6, which is provided to remove large non-degradable items. An example of a primary screen 6 is a rotary drum screen (Wedgewire Screens Ltd of Doncaster, UK). For example, if the waste 7 consists of urban sewage, then such non-degradable items are likely to include plastic products, such as condoms, or other sanitary products etc. From the primary screen 6, the waste 7 is then passed into a pumping station or sump 8, which can also act as a grit trap in small systems. The level of waste 4 in the sump 8 is monitored by a high level switch 36, which prevents waste 4 overflowing.

Duty standby submersible grinder pumps 38 specified to handle the nature of the solids within the effluent stream and available from suppliers such as Lowara or Flygt, grind up the remaining waste 7, and pass the ground material from the sump 8 to a balance tank 10. The balance tank 10 can be a sectional steel, glass lined, open topped tank as supplied by Permastor Ltd., and is used to control the flow and load of waste 7 passing to a series of (NERV) reactors 12. FIG. 2 illustrates the reactor 12 in detail, which will be described in detail hereinafter. FIG. 1 shows the apparatus 2 having three reactors 12. However, the number of reactors 12 in the apparatus 2 can be varied, and depends on the specific type and volume of waste 7 that needs to be treated on any particular site.

The reactors 12 are fed with waste 7 at a constant rate from the balance tank 10 by a pump 44. The flow rate of waste 7 into the reactors 12 is controlled by a programmable logic controller (plc) 40, which responds to ultrasonic level probes 22 mounted at the top of the balance tank 10. Feed of waste 7 from the balance tank 10 in to the reactors 12 varies in speed depending on the level of waste 7 within the balance tank 10, but will never exceed the optimum speed required to run the reactors 12 efficiently.

The apparatus 2 includes a bacteria-dosing unit 20, which delivers measured volumes of pre-selected bacteria 48 cultures in to the waste 7 present in the balance tank 10 prior to inflow into the reactors 12. Normally, the bacteria 48 are provided in a freeze-dried form, although in some circumstances, bacteria 48 can be provided in liquid form, as will be described in further detail hereinafter. Examples of suitable bacteria 48 include strains from the Bacillus family, which are available from commercial suppliers, such as Organica (UK) Ltd or Bio-Systems UK Ltd.

The waste 7 is pumped into the NERV reactors 12 through the top of each reactor vessel 12, and exits the vessels 12 via their base. The apparatus 2 is provided with a series of pumps 44 and valves 46, which serve to control the flow of waste 7, to, from and between each reactor 12. Hence, as shown in FIG. 1, the three reactors 12 are connected together in such a way that waste 7 can be pumped into the top of each reactor 12 either separately, or from one reactor 12 to the next reactor 12 in series.

The reactors 12 operate full at all times and are only emptied for maintenance or servicing. The volume of waste (liquor) 7 within the reactor 12 is monitored, and automatically adjusted by the plc controller 40, which takes its signal from an ultrasonic level sensor 22 in the reactor 12.

After treatment of the waste 7 in the NERV reactor 12, the treated waste liquor 5 is taken from the reactors 12, and passed to a secondary solids removal device 14 to remove any residual solids left. This secondary screening stage 14 can include: a screening stage, a settlement stage, a dissolved air flotation stage, or a combination of each. These items are standard process equipment available from any good wastewater treatment organisation. Depending on the final disposal route of the treated liquors 5, they may pass either directly to a sewer 18 where they circulate with other wastewater streams, or to a further treatment unit 16 for polishing and re-use. For example, the treatment unit 16 can include the following devices: a) an NSAFF (or Nitrifying Submerged Aerated Fixed Film Filter) as supplied by IWT Ltd., and used for the removal of residual ammonia, or b) a reed bed used for polishing relatively clean waste water to river water quality.

The NERV Reactor 12 will now be described in more detail with reference to FIG. 2.

### (2) The NERV Reactor:

The NERV reactor 12 has been designed in such a way that it replaces the traditional concepts of using free breeding (i.e. freely evolving) bacteria as in existing systems of activated sludge programs, to degrade organic waste in urban sewage treatment systems and industrial waste water streams. Instead, the apparatus 2 according to the invention uses a method of controlled dosing and growth of pre-cultured, especially pre-selected strains of bacteria 48 from the dosing unit 20 shown in FIG. 1. The design of each reactor vessel 12 and the NERV process is such that it creates the ideal conditions in which the pre-cultured, pre-selected bacteria 48 can work and grow at their optimum rate, thus maximising the degradation process of the waste stream 7.

The NERV reactor 12 forms the main treatment component in the apparatus 2, and takes in a mixture of waste 7 and pre-specified, pre-cultured bacteria 48 from the dosing unit 20. The specific type of dosing unit 20 used in the apparatus 2 depends on whether the bacteria 48 are supplied in powder form or liquid form. Powder substrate is used where factory drains 72 are to be used as an incubation chamber as shown in FIG. 1. The powder media containing the bacteria 48 is usually heavy (ground up sea shells or pumice) and is designed to sit on the bottom of the drain 72 providing a fixative for the bacteria 48 to adhere to. This enables the bacterial culture to be pre-activated before introduction into the balance tank 10 and NERV reactors 12, and also helps to maintain free flow of product within the drains 72. If the bacteria 48 are to be dosed directly into the drains 72, then the dosing unit 20 consists of a simple auger doser 76.

However, if the bacteria 48 are supplied in liquid form, then they may be fed directly into the balance tank 10. If the bacteria 48 are to be dosed directly into the balance tank 10, and not via the drains 72, then the dosing unit 20 will include a pre-activation chamber 74 in which the bacteria 48 are pre-activated.

The strains of bacteria 48 used will depend on the nature of the waste within the water 7 (e.g. Bacillus spp.) and identification of the bacteria 48 will be achieved by laboratory analytical tests prior to the design of the system. If necessary, nutrients can be added to the culture in the reactor 12 from a nutrient supply 50, but these are usually supplied by the waste 7, that is being treated, and so it is not normally necessary to supply additional nutrients 50.

Referring to FIG. 2, the reactors 12 consists of a tank fabricated from stainless steel or glass-lined carbon steel, which have dished bottoms and tops. The reactors 12 stand in an upright position with the waste 7 entering via waste inlet 52 through the top of the reactor 12, and exiting from the bottom of the reactor 12 via waste outlet 54. The precise dimensions of the reactor 12 will be determined by the volume of waste 7, which requires treatment on the NERV plant, and also how many reactors 12 there are. However, the height of the reactor 12 is at least twice that of the width, and this is required for the efficient running of the reactor 12, and hence, degradation of the waste 7. Therefore, by way of example only, the dimensions of the reactor 12 to handle a flow rate of approximately 100 m³ per day with a Chemical Oxygen Demand (COD) load of approximately 8,000 mg/l and to reduce the COD to 500 mg/l are about 3.5 m wide by about 7 m high. The reactors 12 are free-standing and have man-way hatch access ports 56 for servicing and repair requirements.

The reactors 12 include an ultrasonic level controller 22, which controls the level of waste liquor 7 within the reactor 12 and the operation of the liquor transfer pump in the balance tank 10. The reactor 12 has a mechanical emergency high level switch 32 that will stop all pumping in the unlikely event of it being activated, and a mechanical Low Level switch 30 for emergency shut down should the reactor 12 inadvertently empty.

Conditions are created within the reactor 12, which allows light biodegradable solids (organic waste) in the waste 7 to be retained within the reactor 12 for an indefinite period, such that they are sufficiently degraded by the bacteria 48. This is accomplished by using a novel layout of especially designed air diffuser systems 28, which are disposed towards the base of the reactor vessel 12. As shown in FIG. 2, the reactor has five air diffuser systems 28 mounted at its base. However, it will be appreciated that the number will depend on the overall dimensions of the reactor 12. Referring to FIG. 3, there is shown a plan view of one of the air diffuser systems 28 in more detail. The air diffuser system 28 is circular in cross-section having a diameter of about 3.2 m depending on the diameter of the vessel 12. The air diffuser system 28 consists of a series of concentric circular pipes (not shown) that are mounted on the bottom of the NERV reactor vessel 12. Each row of pipes is connected to an air supply 60 provided with a variable speed positive displacement air blower (supplied by Dresser Routes or Bibus). Each pipe is attached to a series of individual ‘dome’ type air diffusers 34, which point upwardly therefrom. Each individual air diffuser 34 is approximately 360 mm in width and consists of a finely perforated rubber membrane, which expands outwards (upwardly) when air feeding from the air supply 60 is passed through it.

The fine perforations in the rubber membrane emit a very fine bubble matrix at a controlled rate and the configuration of the diffuser system 28 as a whole ensures an equal distribution of air across the diameter of the NERV reactor 12. The number of individual air diffusers 34 mounted on the concentric circular pipes will depend on the diameter of the vessel 12 and the calculated oxygen requirements of the waste to be degraded. A typical NERV reactor 12 will contain about forty eight individual ‘dome’ diffusers 34 with each diffuser 34 delivering about 68 kg of air per hour.

The diffuser systems 28 in the array deliver large volumes of oxygen 68 to support the growth requirements of the bacteria 48 in the culture growing within the reactor 12. In addition, sufficient air 68 is provided by the diffuser systems 28 in order to provide sufficient lift of the bacteria 48 and waste particles 7, but without producing excessive turbulence. Turbulence would disturb the optimum flow pattern within the vessel 12 and affect the zones of treatment, and so has to be avoided as much as possible. For example, the flow rate of air 68 being pumped through all of the diffuser systems 28 is about 3,250 kilograms per hour. A dissolved oxygen probe 24 is positioned within the reactor 12 in order to monitor oxygen use and aeration efficiency. Aeration adjustments can be made by altering the speed of the positive displacement blowers in the air supply 60.

The aim of the NERV process is to keep the less dense, lighter, and more easily degraded organic solids 62 at the top of the reactor tank 12. This is so that they are retained within the reactor 12 for sufficient periods of time (i.e. the retention time of the waste 7 in the reactor 12) to allow sufficient digestion thereof to take place. As will be described hereinafter in section (3) below, the waste 7 flows down through an increasingly oxygenated and bacteria-rich region through the reactor 12 before being discharged through the outlet 54 at the bottom of the reactor 12.

### (3) Operation of the NERV Reactors:

With reference to FIG. 2, the correct size of the reactor vessel 12 is established by carrying out treatment tests in laboratory bench trials. The laboratory bench trials will enable those bacteria 48 cultures, which will degrade the waste matter most efficiently to be identified and tested. This information will enable the reactors 12 to be correctly sized and other process information such as the requirement for additional nutrients, temperature, and pH correction to be established.

The reactors 12 operate most efficiently when the flow rate and load are stable (minimum peaks and troughs). It is recommended that the wastewater 7 is delivered to the reactor 12 via the flow and load balance tank 10, which is specified to provide at least 12 hours retention time as a minimum requirement and preferably 24 hours retention time where space is available. When the reactors 12 are first started during a commissioning period, each reactor 12 is initially ‘charged’ by:—
1. closing all outlet valves 46;
2. partly filling the reactor 12 with clean water;
3. turning on the air supply 60 to activate the air diffuser systems 28;
4. pre-seeding the reactor vessel 12 with the required bacteria 48 directly from the dosing unit 20;
5. completing the ‘full’ with the waste water 7 mixed with further bacteria 48 either directly from the auger doser 76 or via the factory drains 72.

After ‘charging’ the reactor 12 as detailed above, the flow of additional waste 7 to the vessel 12 is allowed to continue from the balance tank 10 under the control of the programmable logic controller 40 until it is ‘full’. Additional fresh batches of bacteria 48 are dosed into the feed line inlet 52 to the reactor 12 at a pre-determined rate, or into the balance tank 10. Air bubbles 68 are produced at the bottom of the reactor 12 via the array of air diffuser systems 28. The air 68 supplied by the diffuser systems 28 has two functions. Firstly, the air 68 delivers sufficient oxygen to the bacteria 48 at the required rate such that bacterial growth and metabolism is possible. The growing bacteria simultaneously digest and degrade the waste 7 in the reactor 12.

Secondly, the diffused air 68 supply provides a fine bubble matrix or aeration matrix 26 throughout the reactor 12, as illustrated in FIG. 2. This aeration matrix 26 supports lighter, less dense solids 62 and also lighter flocculated material within the upper sections of the reactor 12.

As shown in FIG. 2, when in use, three zones are created within the reactor 12 due to the aeration matrix 26 caused by the array of air diffuser systems 28:—
1. A Solids Stabilisation zone 26c;
2. A Contact Stabilisation zone 26b; and
3. A High Oxygenated zone 26a.

Fresh effluent 7 fed into the reactor 12 has been put through a grinder pump 38 to reduce the particle size in order to allow the aeration matrix 26 to retain the undigested solid particles in the vessel 12 for as long as possible. Waste 7 and fresh bacteria 48 are continually applied to the reactor 12 via inlet 52, such that the bacteria 48 begin to form flocculations (or bio-floccs) around the undigested particles 62 in the waste 7. Lighter undigested waste and biofloccs 7 are retained indefinitely by the aeration matrix 26 within the Solids Stabilisation zone 26c in the upper regions of the reactor 12.

The formation of bio-floccs around the particles of waste 62 results in accelerated digestion thereof in the Solids Stabilisation zone 26c. The digestion of organic matter is a complex process. However, briefly, the bacteria 48 produce enzymes, which break down the cellular components of the particles of organic matter 62 into components that can be easily digested by the bacteria 48. This then becomes the food source or substrate for the bacteria 48. Maintenance energy is that part of the energy requirements of the cell that is used to maintain the cell in a viable state, for example, for re-synthesis of cell constituents which are continuously being degraded, growth, and for maintaining concentration gradients between the interior and exterior of the cell. Maintenance respiration is carried out by the bacteria 48, when the substrate concentration provided by the organic waste matter 62 is sufficiently high.

As the waste particles 62 become digested in the solids stabilisation zone 26c by the bacteria 48, the particles 62 are transformed into heavier particles 64, which travel down from the solids stabilisation zone 26c into the Contact Stabilisation zone 64 in the middle regions of the reactor 12.

### (i) ‘Contact Stabilisation’ (Flocculation of Biomass)

Relative motion of particles (undigested waste 62 and bacteria 48) in the reactor 12 is caused by (a) Brownian movement; (b) by fluid movement giving rise to velocity gradients, (c) and by particle motion due to an external force (e.g. gravity). The rate of flocculation is determined by the collision frequency induced by the relative motion between these particles. Flocculation caused by Brownian movement, it is called ‘perikinetic flocculation’, and the flocculation caused by velocity gradients is called ‘orthokinetic flocculation’. If there is no surface repulsion between the particles of waste 62 and bacteria 48, then every collision leads to aggregation and the process is called ‘rapid flocculation’. However, if a significant amount of repulsion occurs between the particles of waste 62 and bacteria 48, then only a fraction of the collisions results in aggregation, and this is called ‘slow flocculation’.

Hence, the contact stabilisation zone 26b allows fragile floccs 64 to form in the middle section of the reactor 12, and without the production of any high shear pressures caused by any turbulence. The larger floccs 64 form a sound substrate for bacteria to attach to and grow on. Surprisingly, it is possible for the contact stabilisation to take place in one tank or vessel 12, thereby reducing the footprint required for the overall apparatus 2.

In the contact stabilisation zone 26b, the flocculations 64 mature and grow in size and become even heavier. As the particles 64 become heavier, they travel down from the contact stabilisation zone 26b into the High Oxygenated zone 26a at the bottom of the reactor 12 as large flocculations 66 where further rapid Biological Oxygen Demand removal takes place. The formation of large flocculations provides a large surface area for bacteria 48 to accumulate and operate, and eventually digest the organic matter. The digested organic matter eventually exits from the base of the reactor 12.

During the normal operation of the apparatus 2, the reactors 12 work in senes. Hence, the action of the bacteria 48 within the reactors 12 degrade the organic component of the waste matter 7, with some of the inorganic components being absorbed by the bacteria 48 during their natural metabolism to provide maintenance energy requirements. The action of the bacteria 48 will clean the wastewater 7 as it passes down through the reactor vessel 12 from the upper stabilisation zone 26c, through the contact zone 26b, and down into the lower high oxygenated zone 26a. Continued degradation of the suspended solids 62,64,66 within the reactor 12 is therefore effectively carried out.

Heavy solids 66 exit the reactor 12 with the normal flow of treated water 5 through outlet 54, together with a small amount of surplus biofloc or sludge. If required, the surplus solids can be extracted by a sludge removal device 70, as shown in FIG. 1. For example, a Tangential Flow Separator (as designed and built by Heaton Green Engineering Ltd.) is an efficient solids separation device requiring little power and maintenance, which will allow the surplus solids sludge to be removed, and a clean liquor 5 to pass to a drain or a final treatment process 16.

The NERV reactor 12 allows two key features to be carried out. Firstly, as described in section (ii) above, the reactor 12 allows ‘contact stabilisation’ (flocculation of biomass) to take place in one vessel 12 rather than in two (as in the prior art), and with much greater efficiency. This is made possible by the array of air diffuser systems 28, which maintain the organic waste particles 62,64,66 in the upper sections of the reactor 12 such that bioflocculations can actively form. The oxygen concentrations are higher and metabolic degradation of the waste is therefore possible.

Secondly, the reactor allows the bacteria 48 to enter into an endogenous respiration phase (described in further detail in (ii) below), such that less sludge is produced as a waste product of the process. Hence, there is less burden on the sludge removal device 70. In addition, costs associated with depositing any sludge are significantly reduced compared to those incurred in existing systems.

### (ii) Maintenance and Endogenous Respiration

As mentioned above, maintenance energy is that part of the energy requirements of the cell that is used to maintain the cell in a viable state, for example, for re-synthesis of cell constituents which are continuously being degraded, growth, and for maintaining concentration gradients between the interior and exterior of the cell. Maintenance respiration is carried out by the bacteria 48, when the substrate concentration provided by the organic waste matter is sufficiently high.

However, as the bacteria 48 digest the organic waste matter, the substrate concentration in the waste reduces to levels such that maintenance digestion is unable to be carried out. Endogenous respiration is a metabolic process, which occurs in the bacteria 48 when the nutrients are removed or substantially reduced from the reactor 12, and is an alternative mechanism by which the bacteria 48 can produce their energy requirements, by using some of their own material as energy substrate. When bacteria 48 enter the endogenous respiration phase, and an oxygen supply 68 is maintained, they have a tendency to enter a ‘cannibalistic’ form in which they begin to feed off, and hence, consume their own dead biomass. Hence, the endogenous metabolism refers to cell-internal reactions that occur within the micro-organisms in the absence of externally supplied substrate. Generally, a consumption of oxygen or nitrate is observed during this endogenous respiration stage, phase along with a decrease of biomass concentration.

The inventors of the present invention have found that by tightly controlling the extent to which endogenous respiration occurs within the reactor 12, it is possible to control the concentration of biomass in the reactor 12, which is then produced as sludge. Accordingly, by controlling the endogenous respiration phase in the reactor 12, it is possible to cause a substantial reduction in the concentration of solid particles 66 discharged from the reactor 12, and hence, NERV process in apparatus 2. This is a major advantage over existing activated sludge processes in which large volumes of sludge are produced, and which require disposal. Disposal of sludge is a costly process, and significantly adds to the overall costs of the treatment plant.

The control of the endogenous respiration phase within the reactor 12 is carried out as follows. Once the reactor 12 is full, the flow of any further waste 7 into the reactor 12 is interrupted. In addition, the flow of liquor 5 out of the vessel 12 is also interrupted. Hence, the volume of waste 7 in the reactor 12 is kept constant. In addition, the level of aeration provided by the air diffusion systems 28 is continued for a pre-determined period of time so that the bacteria 48 within the reactor 12 have a supply of oxygen for them to digest their own biomass using endogenous respiration. The preferred endogenous respiration phase time can be assessed during laboratory trials, or by conducting on-site tests during the commissioning of the vessel 12.

In order to maximise the ‘endogenous respiration’ phase, the reactors 12 in the apparatus 2 are connected so that they can be run independently of one another. Hence, when a first reactor 12 is arranged to enter into the endogenous respiration mode, further waste 7 can be fed into a second (and other) reactor 12 so that the apparatus 2 is not out of action for any prolonged periods. In this way, the first reactor 12 is set up to digest the majority of the bacterial biomass grown up with the reactor 12, while a second reactor is set up to digest ‘fresh’ waste material from the balance tank 10.

Once the endogenous respiration phase has been completed, the first reactor 12 is then fed with fresh wastewater 7 and the inflow and outflows re-initiated as previously. This allows the reactor 12 to return to the situation where waste is being degraded and the bacteria 48 can rely on the fresh waste substrate to provide their maintenance energy.

The retention times for treatment of the wastewater 7 depend on the Biological Oxygen demand (BOD) and Chemical Oxygen Demand (COD) loading and physical nature of the waste water 7 entering the reactor 12. By way of example only, the NERV process may require a retention time as low as 3 hours for waste streams having a COD loading of 8,000 mg/l or less. However, where loading rates are particularly high (COD levels in excess of 50,000 mg/l), the retention times will have to be longer, in which case the NERV reactors 12 can be installed in pairs or banks of pairs.

The long retention time created by keeping the lighter undigested waste particles 62 within the reactor 12 ensures a maximum degradation potential for the organic matter. The efficiency of the action of the bacteria 48 on the waste 7 within the water is dictated by a number of factors, such as:—
1. The species of bacteria 48 species to be fed into the reactor 12.
2. The amount of oxygen 68 available to allow the bacteria 48 to exist and proliferate.
3. The nutrient levels within the reactor 12.
4. The pH of the contents of the reactor 12 (maintained at about 6.5-7.0).
5. The temperature within the reactor 12 (maintained at about 30° C.).
6. The retention time of the contents (i.e. contact time between the digesting bacteria 48 and the waste particles 62).

Operational requirements of the NERV apparatus 2 include:—
1. Maintaining bacteria 48 stocks and levels in the dosing unit 20.
2. Cleaning the bacteria-dosing unit 20.
3. Inspecting the entire apparatus 2 for leaks.
4. Emptying any surplus solids container 70.
5. Cleaning the area.
6. Observing the control status of the apparatus on a control panel (not shown).

All other duties can be carried out or monitored remotely such as:—
1. Monitoring oxygen levels via the dissolved oxygen probe 24.
2. Checking pH and temperature with standard probes.
3. Checking flow rates.
4. Checking pump 40, 44 status and valve 46 integrity.

Checking levels in the various tanks and reactors 12.

In summary, the NERV reactor 12:—
1. allows total control over the use of specific strain bacteria 48 cultures in a bio-reactor 12 process. This is made possible using the bacterial dosing unit 20.
2. allows the phase of ‘endogenous respiration’ to be controlled to allow the assimilation of dead biomass as a food source thus reducing sludge volumes. This is made possible by stopping the inflow and outflow of waste 7 and continuing to aerate the reactor to provide the bacteria with oxygen for the endogenous respiration to occur.
3. allows the process of ‘contact stabilisation’ (flocculation of biomass). This is made possible by pumping in the waste 7 into the top of the NERV reactor 12 and pumping out digested waste from the bottom of the reactor 12. The arrangement of the air diffusion systems 28 at the bottom of the reactor 12, forms an aeration matrix 26 which provides lift to the waste such that flocculations between the waste particles 62,64,66 and the bacteria 48 are formed.

### Conclusions

In prior art activated sludge processes, aerobic biological systems may use more than one vessel where the bioflocc produced in the primary aeration process is very weak. A second process vessel, which stirs rather than aerates, is used to allow the biofloc time to form. Hence, more than one vessel is required.

However, because the NERV reactor 12 of the present invention holds light solids 62 at the top of the tank for an indefinite period (until full degradation takes place or the flocc grows to a size that allows it to fall against upward the flow of air), the period of contact stabilisation is allowed to take place as a primary function of the reactor vessel 12. The air diffuser systems 28 are arranged such that sufficient lift is provided within the reactor 12 to maintain the bio-floccs in the upper portions of the reactor 12, but so that turbulence is minimised, which would otherwise disrupt the bio-floccs. It is advantageous to keep the floccs in one piece and in the upper parts of the reactor 12 so that digestion by the bacteria is possible. If the aeration was too aggressive, then the biofloccs would be disrupted and the rate of digestion of the waste would be reduced.

Another unique feature of the NERV is the ability to control the period of endogenous respiration occurring therein. This is carried out by turning off the feed via the inlet 52, but retaining the aeration 68 and concentration of the bacteria 48 in the vessel 12. The process is allowed to stand for a defined period of time (a number of hours, or for any period if the NERV reactors 12 are stacked in banks of two or more in series), so that the bacteria 48 can concentrate on and digest further the heavier organic solids 66 and the biofloccs.

When the nutrient levels are depleted within the reactor 12, the bacteria 48 revert to the endogenous respiration phase and start to consume their own biomass. Hence, advantages of the NERV apparatus 2 reside in the following benefits. The apparatus 2 and, hence, system process occupies much less space than traditional biological systems. The NERV reactor 12 has been designed in such a way that it replaces the traditional concepts of using free breeding (i.e. freely evolving) bacteria as in existing methods. Unlike existing activated sludge methods used to treat effluent, the process does not rely on self-generating bacterial cultures, due to the bacterial dosing unit 20. Therefore, it will always have the correct and most efficient bacterial strains applied to the wastewater or organic waste 7. The process is able to handle a wide range of loading and flow rates within the same system.

The process is particularly resilient to toxic shocks, and can recover quickly and automatically should a toxic wipe out occur. The process is very simple to operate. The process is able to operate with a high level of automation with minimum operator attention. By allowing the Endogenous Respiration phase to be optimised, the system produces significantly less residual bio-sludge than traditional systems, thereby reducing the transportation and dumping of solid waste into the environment. In currently used methods, there is a requirement to maintain the bacterial culture, and increase the biomass concentration as much as possible as it is believed that this provides more biomass for degrading the waste. However, a consequence of this is that traditional urban waste-water treatment suffers from high sludge transportation and disposal costs. Hence, the use of the NERV process in this industry would dramatically reduce sludge disposal costs and overall sewage treatment costs.

The NERV system 2 allows the process of ‘Contact Stabilisation’ to take place in one reactor vessel 12. The process can be monitored and operated from remote locations allowing a centralised control room to oversee a large number of systems. The concept of activated sludge and the use of live sludge cultures can still be used in the system. The advantage of the NERV process is the low solids levels produced compared to traditional biological treatment systems.

Finally, the NERV process 2 can be retrofitted to existing wastewater treatment systems to improve their performance or to replace old, worn out and non-functioning parts.

### Example 2

The inventors carried out a wastewater treatment trial using the apparatus as shown in FIG. 1. The trial was carried out on cooked turkey wastewater.

Loading rates before treatment were as follows:—

Flow: 8 m³ per hour, 16 hours per day.

COD leaving factory and entering drain: 9,000 mg/l average

Solids disposal per week: 5 tonnes

Using the apparatus 2, the pH within the process was maintained at a constant 6.5 to 7 for best results. The temperature stabilised at approximately 30° C. The flow rates to be treated per vessel (assuming each vessel is fixed at 50 tonnes capacity) was 5 to 10 tonnes of waste water per hour depending on loading and the required endogenous respiration time scale.

The rates following treatment in the trial reactor 12 were as follows
Flow: 8 m³ per hour, 16 hours per day, the remaining 8 hours were used for putting the system into endogenous respiration mode.
COD (after treatment): 1,500 mg/l average.
Solids disposal per week: 0.5 tonnes

From the results given above, it will be appreciated that treatment of the wastewater in the apparatus 2 causes a dramatic reduction in the Chemical Oxygen Demand (COD) of the water (a decrease of about 84% COD). Furthermore, following treatment with the apparatus 2, there was a reduction in the total solids of about 90%. In addition, the effect on urban wastewater was total removal of organic solids during test periods. This would obviously have a profound effect on the existing sewage treatment industry as even a 50% removal of organic solids would reduce overheads dramatically due to reduced transport and disposal costs of sewage sludge.

### Example 3

The inventors carried out a further wastewater treatment trial using the apparatus as shown in FIG. 1. This trial was carried out on cooked chicken processors in Morecambe, Lancs. Hence, the inventors were able to compare the efficiency of the treatment using the NERV reactor system 2 with an existing treatment regime using a Dissolved Air Floatation device (ie. a DAF cell).

The existing DAF system produces 15 tonnes of sludge per week and reduced incoming CODs from 80,000 mg/l down to 16,000 mg/l. This equates to a COD reduction of 80%.

However, in comparison, the trial NERV system 12 showed a reduction of incoming COD from 80,000 mg/l down to 3,000 mg/l with a total sludge production of 5 tonnes per week. Hence, it will be appreciated that there is a significant reduction not only in the COD value, but also in the total amount of sludge, which is produced, by using the apparatus and methods according to the invention. In fact, a COD reduction by 96.25% is obtained, and only a third of the volume of sludge is produced than would have been produced using the DAF system. It will be appreciated the significant advantage of the apparatus and method according to the invention is the significant reduction in sludge volumes down from 15 tonnes per week to 5 tonnes total per week. In addition, an advantage is that much less chemical flocculant enhancer is required and the DAF cell is used for polishing rather than full treatment.

### Example 4

### Pilot Tests on Decanted Sewage Sludge Liquors from a Sludge Thickening Process Large sewage treatment works generally have three kinds of sludge: —Primary settled sludge, surplus activated sludge, and digested sludge. The first two are sent for thickening prior to being digested. The third is dewatered prior to disposal.

The liquors coming from these processes are abnormally high in COD/BOD and ammonia. The liquors are returned to the head of the works for dilution and treatment. Because of the low strength of urban sewage waste, these liquors form a major proportion of the load handled by the works. Works often fail because this load becomes too high and causes difficulties with meeting environmental discharge consent limits. Until now, the only solution on sites where these liquors are causing major problems has been to increase the infrastructure of the main treatment works at excessive cost.

The NERV process has now been successfully tested on these liquors at Scunthorpe STW and has shown the following:—

a) Decanted Liquor strength reduced from 12,000 mg/l COD down to 1,000 mg/l COD.
b) Ammonia reduced from 532 mg/l down to 170 mg/l.

The NERV process offers a small footprint process at far less cost than conventional remedies. The addition of the NERV process on the sludge liquors would effectively allow up to ⅓^{rd} additional working capacity within a sewage works without the need for extensive modifications or alterations and excessively high costs.

The process also produced settleable solids with a robust flocc that gave far better settlement characteristics than normal untreated sludge liquors. This lead to a smaller sludge/liquor volume for handling with efficiencies in equipment performance.

1-35. (canceled)

36. Waste treatment apparatus for the microbial treatment of waste, the apparatus comprising at least one reactor vessel for containing waste, waste feed means adapted to feed untreated waste into the vessel, microbial feed means adapted, in use, to feed micro-organisms into the waste, aeration means adapted to aerate the waste in the vessel, and waste outlet means adapted to remove treated waste from the vessel.

37. Waste treatment apparatus according to claim 36, wherein the microbial feed means comprises a culture vessel in which micro-organisms are cultured prior to feeding into the waste.

38. Waste treatment apparatus according to claim 37, wherein the culture vessel comprises an activation chamber in which the micro-organisms are fed nutrients and maintained at the correct temperature in order to accelerate the microbial activation process.

39. Waste treatment apparatus according to claim 37, wherein the microbial feed means comprises dosing means, which is adapted to automatically dose or feed a pre-determined quantity of micro-organisms from the culture vessel into the waste.

40. Waste treatment apparatus according to claim 39, wherein the microbial feed means comprises a timer adapted to control when the dosing means feeds the micro-organisms into the waste.

41. Waste treatment apparatus claim 36, wherein the micro-organisms, which are used to treat waste are selected from a group consisting of Bacillus spp., Lactobacillus spp, Pseudomonas spp., Cellulomonas spp., Micrococcus spp., Thiobacillus spp., and Sacchormyces spp.

42. Waste treatment apparatus according to claim 36, wherein the waste feed means is adapted in use to feed untreated waste towards or into an upper region of the reactor vessel.

43. Waste treatment apparatus according to claim 36, wherein the waste outlet means is adapted to remove treated waste from a lower region of the reactor vessel.

44. Waste treatment apparatus according to claim 36, wherein the aeration means is adapted to produce a plurality of gas bubbles, which bubbles rise up from the lower region of the vessel and provide lift to particles of waste, micro-organisms, and flocculations thereof inside the vessel.

45. Waste treatment apparatus according to claim 36, wherein the aeration means comprises at least one gas diffusion means disposed substantially at or towards a lower region of the inside of the vessel.

46. Waste treatment apparatus according to claim 36, wherein the aeration means comprises a plurality of gas diffusion means, disposed at or towards the base of the vessel, each of which points substantially along the longitudinal axis of the vessel.

47. Waste treatment apparatus according to claim 45, wherein the aeration means comprises a gas supply in communication with the or each gas diffusion means via a gas conduit.

48. Waste treatment apparatus according to claim 47, wherein the gas comprises oxygen, which is provided to enable the micro-organisms to grow and digest the waste inside the vessel.

49. Waste treatment apparatus according to claim 47, wherein the or each gas diffusion means comprises support means and at least one aperture extending therethrough, which aperture is in communication with the gas conduit.

50. Waste treatment apparatus according to claim 49, wherein the gas diffuser comprises a membrane disposed over the or each aperture, which membrane is perforated.

51. Waste treatment apparatus according to claim 50, wherein the perforations in the membrane are formed as apertures or narrow slits in the membrane, which are adapted to open up as gas is pumped therethrough.

52. Waste treatment apparatus according to claim 36, wherein the apparatus comprises means for removing undigestible particles from the waste prior to feeding into the vessel.

53. Waste treatment apparatus according to claim 36, wherein the apparatus comprises a plurality of reactor vessels, which are adapted to run either independently from, or simultaneously with, each other.

54. A method of microbially treating waste, the method comprising the steps of:
(i) feeding untreated waste into at least one reactor vessel via waste feed means;
(ii) feeding micro-organisms into the waste via microbial feed means;
(iii) aerating waste in the vessel via aeration means; and
(iv) removing treated waste from the vessel via waste outlet means.

55. A method according to claim 54, wherein steps (i), (iii) and (iv) are continuous.

56. A method according to claim 54, wherein the method comprises temporarily stopping untreated waste from being fed into the reactor vessel, stopping treated waste from being removed out of the vessel, and continuing to aerate the waste present in the reactor vessel, to thereby provide further oxygen to the micro-organisms therein so that they use endogenous respiration.

57. A method according to claim 56, wherein following the endogenous respiration phase, the method comprises feeding further untreated waste into the reactor vessel, and removing further treated waste from the vessel.

58. A method according to claim 54, wherein the method comprises a series of steps comprising (a) continuously feeding and removing waste from the reactor; (b) maintaining a volume of waste in the reactor vessel for a defined period to allow endogenous respiration to occur; and (c) then re-feeding further waste and removing said waste from the reactor.

59. A method according to claim 54, wherein the method comprises using a plurality of reactor vessels, which are operably connected in series with each other, and feeding untreated waste by the waste feed means to a first vessel for a defined period of time, and then depending on the stage of the waste treatment, feeding waste from the waste outlet means of the first vessel to the waste feed means of a second vessel, and so on.

60. A method according to claim 59, wherein when a first reactor vessel is arranged to enter into the endogenous respiration mode, further waste is fed into a second (and other) reactor vessel so that the apparatus is not out of action for any prolonged periods.

61. A method according to claim 60, wherein once the endogenous respiration phase has been completed, the first reactor vessel is then fed with fresh untreated waste, and the inflow and outflows re-initiated, and wherein the second reactor vessel is induced to enter the endogenous respiration phase by stopping inflow and outflow of waste, but continuing aeration such that the amount of waste is reduced.

62. A method according to claim 54, wherein the biological activity in the reactor vessel is monitored by dissolved oxygen probes, which are operably linked to a controller and processing means.

63. A method according to claim 62, wherein information is fed from the controller and processing means through a modem to a remote terminal, which is remotely situated (e.g., in another town, or country) with respect to the reactor vessel, and from which a central control unit may manage the entire process.
